(19) United States
(12) Patent Application Publication
(10) Pub. No.: US 2002/0059626 A1
(43) Pub. Date: May 16, 2002

(54) System and method for optimizing broadcast bandwidth and content

(76) Inventor: Thomas Lemmons, Evergreen, CO (US)

Correspondence Address: The Law Offices of William W. Cochran, LLC, 3555 Stanford Road, Suite 230, Fort Collins, CO, 80525, US

(21) Appl. No.: 09/935,873

(22) Filed: Aug. 23, 2001

Related U.S. Application Data
(60) Provisional application No. 60/227,823, filed on Aug. 25, 2000.

(51) Int. Cl. H04N 7/173

(52) U.S. Cl. 725/95

(57) ABSTRACT

Information received from television receivers is processed to determine channels viewed. Channels not viewed may be reallocated as data channels to support data services. If information received from a television receiver indicates that a channel assigned to data services is tuned for viewing, data services are cancelled or reassigned and broadcast of a program is restored in that channel. In another embodiment of the invention, channels not viewed are transmitted at a reduced data rate, and bandwidth made available by the reduction in data rate may be assigned for data services. If information received from a television receiver indicates that a channel configured for reduced data rate transmission is tuned for viewing, data services are cancelled, reduced, or reassigned and the program is broadcast at a higher data rate. A software program operable on a receiver transmits channel information when the receiver is enabled or when a channel is selected.

### CROSS REFERENCE TO RELATED APPLICATIONS

This application is based upon and claims priority of U.S. provisional application serial No. 60/227,823 entitled “A SYSTEM AND METHOD FOR OPTIMIZING BROADCAST BANDWIDTH AND CONTENT”, filed Aug. 25, 2000 by Thomas Lemmons, the entire disclosure of which is herein specifically incorporated by reference for all that it discloses and teaches.

### BACKGROUND OF THE INVENTION

1. Field of the Invention

The present invention relates to subscriber networks as may be employed to carry television or other subscriber services and, more particularly, to a method and system of optimizing utilization of available bandwidth.

2. Description of the Background

Television broadcast networks, such as cable television systems and satellite television systems, frequently provide data services to customers. Such data services may include Internet access, news services, market information, sports, or other services. These services may employ broadcast channels for downstream data transfer. As the number of data service subscribers increases, the network operator may elect to employ additional downstream channels, or if additional channels are not available, the network operator may attenuate the bandwidth available to each user. The bandwidth available may limit the number of customers that may be supported, reducing revenue generated, and attenuated bandwidth may result in reduced customer satisfaction.

Some cable system operators may broadcast all channels in their lineup continuously, twenty-four hours of every day of the year. Occasionally, one or more channels may be “Off the Air”, but the cable system operator may utilize the bandwidth of the channel to simply transmit a notice on the channel indicating that the program is off the air. Further, there may be times when no viewers tune a certain channel, as may occur during times of low usage, such as between the hours of midnight and five AM on workdays, for example. Channels not being viewed, either through being off the air or whatever reason, offer an opportunity for the bandwidth to be allocated to other services, such as Internet access. Therefore a new method, operable to determine a channel or channels not being viewed and to allocate non-viewed channels to other services, is desired in order to improve data services bandwidth, thereby creating the opportunity for an increased number of users, increased revenue and increased customer satisfaction.

### SUMMARY OF THE INVENTION

The present invention overcomes the disadvantages and limitations of the prior art by providing a system and method of monitoring channel viewing and reallocating non-viewed channels for data services. Receivers in a network are configured to transmit indicators of the channel viewed. A unit located at the head-end, or in communication with the head-end, compiles information from the indicators to determine which channels are tuned. Channels not tuned by a receiver may be allocated for data services. If a receiver is tuned to a channel that has been allocated for data services, the present invention restores broadcast of the program scheduled for that channel.

The invention may therefore comprise a method of managing television network bandwidth comprising: broadcasting a plurality of programs on a plurality of channels to a plurality of receivers across the network; identifying each channel of the plurality of channels that is tuned by at least one receiver of the plurality of receivers connected to the network; determining if one channel of the plurality of channels is not tuned by any one of the plurality of receivers; and if one channel of the plurality of channels is not tuned by any one of the plurality of receivers, broadcasting information other than a program on that channel.

The invention may further comprise a method of managing television network bandwidth comprising: broadcasting a plurality of programs on a plurality of channels to a plurality of receivers across the network; identifying each channel of the plurality of channels that is tuned by at least one receiver of the plurality of receivers connected to the network; determining if one channel of the plurality of channels tuned is a channel that has been reallocated as a data service channel; and if one channel of the plurality of channels tuned by any one of the plurality of receivers is a channel that has been reallocated as a data service channel, reestablishing broadcast of a program on that channel.

Further yet, the present invention provides for reduced bandwidth transmission of non-viewed channels such that viewers switching through channels may be provided with an indication of the program content, and if a viewer tunes to a channel for a specified duration, the bandwidth of the channel is restored to normal broadcast rates.

The invention therefore may further yet comprise a method of managing television network bandwidth comprising: broadcasting a plurality of programs on a plurality of channels to a plurality of receivers across the network; identifying each channel of the plurality of channels that is tuned by at least one receiver of the plurality of receivers connected to the network; determining if one channel of the plurality of channels is not tuned by any one of the plurality of receivers; and if one channel of the plurality of channels is not tuned by any one of the plurality of receivers, broadcasting a program on that channel at a reduced data rate.

The invention may further still comprise a method of managing television network bandwidth comprising: broadcasting a plurality of programs on a plurality of channels to a plurality of receivers across the network; identifying each channel of the plurality of channels that is tuned by at least one receiver of the plurality of receivers connected to the network; determining if one channel of the plurality of channels tuned is a channel that has been configured to operate at a reduced data rate; and if one channel of the plurality of channels tuned by any one of the plurality of receivers is a channel that has been configured to operate at a reduced data rate, configuring that channel to operate at a higher data rate.

Advantageously, the present invention provides a system and method well suited to automated reallocation of channel bandwidth when a channel is not viewed. The reallocated bandwidth may be employed for data services and may be used to provide higher transfer rates to a group of users, or may be used to support additional users, or both. The present invention also provides method to restore program broadcast if program content comprises a commercial message or a public service message. The present invention is also applicable to ‘mixed’ systems comprising both receivers capable of sending upstream messages, and receivers not capable of sending upstream messages. In such systems, the present invention may be employed to reallocate bandwidth associated with channels that are accessed only by request, such as pay per view channels. Additionally, some systems may broadcast both analog and digital television formats wherein digital receivers may provide upstream communication, allowing reallocation of bandwidth of non-viewed digital channels.

### DESCRIPTION OF THE FIGURES

In the figures,

FIG. 1 depicts a cable television broadcast system employing the present invention.

FIG. 2 is a diagram illustrative of the NTSC frequency map for standard 6-MHz cable television channel bands in North America.

FIG. 3 depicts a set top receiver.

FIG. 4 depicts the format of MPEG packets.

FIG. 5 depicts an algorithm for reassigning channels.

FIG. 6 depicts an algorithm for restoring service.

FIG. 7 depicts a second algorithm for reassigning channels.

FIG. 8 depicts a second algorithm for restoring service.

FIG. 9 depicts operation of a software program that may be employed by a receiver to transmit channel information to a head-end system or node of a network.

### DETAILED DESCRIPTION OF THE INVENTION

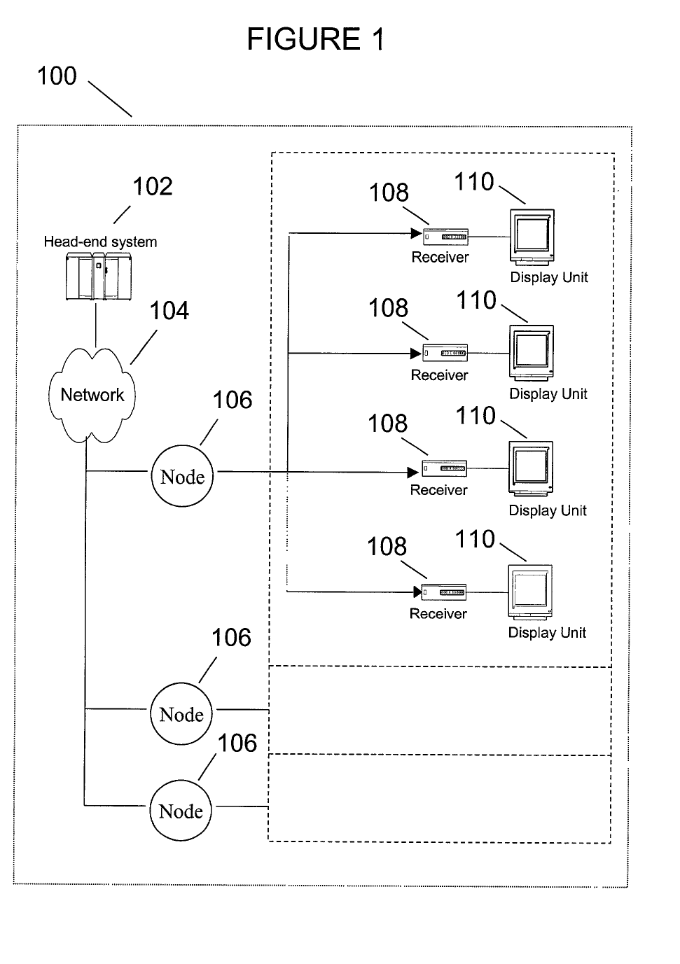

FIG. 1 depicts a cable television broadcast system 100 comprising head-end system 102, network 104, nodes 106, receivers 108, and display units 110. Head-end system 102 delivers television programming to the receivers 110, via network 104 and nodes 106. Head-end system 102 may comprise components from R.L. Drake Company located at 230 Industrial Drive, Franklin, Ohio 45005 U.S.A. or components from Cisco Systems Inc., located at 170 West Tasman Dr. San Jose, Calif. 95134 USA.

Network 104 may comprise fiber optic, coaxial cable, terrestrial or satellite transmission, or combinations thereof, as is common to the art. Nodes 106 are frequently coaxial cable but are not limited to this material. Receivers 108 convert the incoming programming information into a format appropriate for input to display units 110, and thus for viewing by end users of the system 100. Receivers 108 may comprise set-top boxes, personal computers, interactive televisions, or other equipment operable to process television signals and other information, such as control information and program guides, for example. Display units 110 may comprise televisions, computer monitors, or other devices operable to display video images.

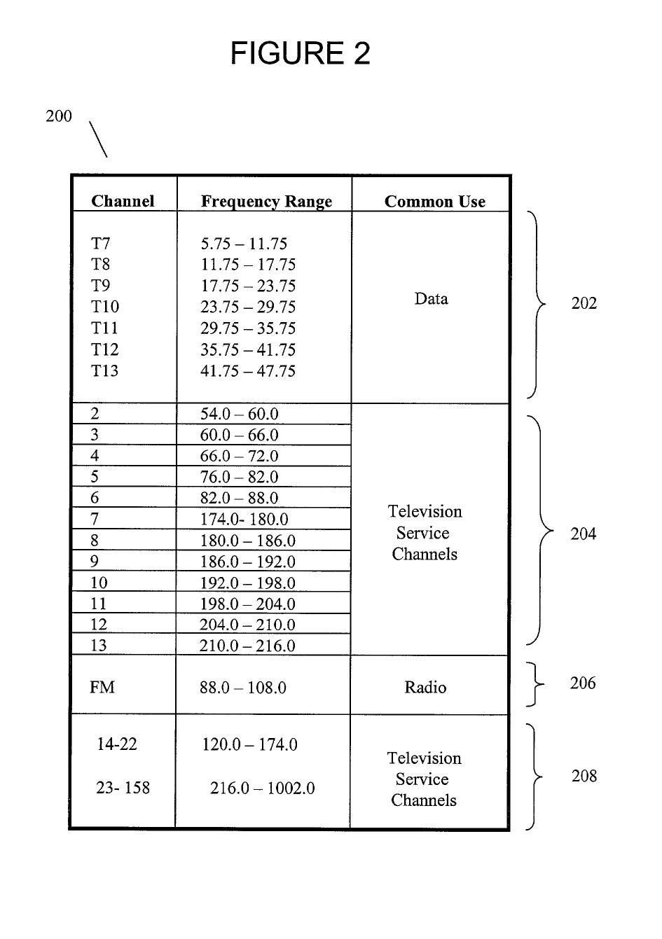

Television broadcast typically employs frequency division multiplexed signals wherein a plurality of programs is broadcast simultaneously, each in a predefined frequency range, or channel. FIG. 2 is illustrative of the NTSC frequency map for standard 6-MHz cable television channel bands in North America. Label 202 of FIG. 2 indicates frequencies that may be employed for data transfer, such as may be utilized for upstream data transfer by cable modems or set top boxes. Label 204 indicates the frequencies assigned to television channels two through thirteen. Label 206 indicates the frequencies assigned to FM radio. Frequencies indicated by labels 204 and 208 are referred to as service channels. Label 208 indicates frequencies assigned to channels 23 to 158 wherein each channel shares an adjacent 6 MHz band. Other standards, such as Phase Alternating Line (PAL) and Systeme Electronique Couleur Avec Memoire (SECAM) employ an 8-MHz channel band.

Head-end system 102 transmits signals, to receivers 108, comprising a number of predefined video service channels, each video service channel occupying a separate portion of available spectrum. A video service channel is a channel, conforming to a standard, either public or proprietary, that may contain a video program. A video service channel may employ analog or digital formats.

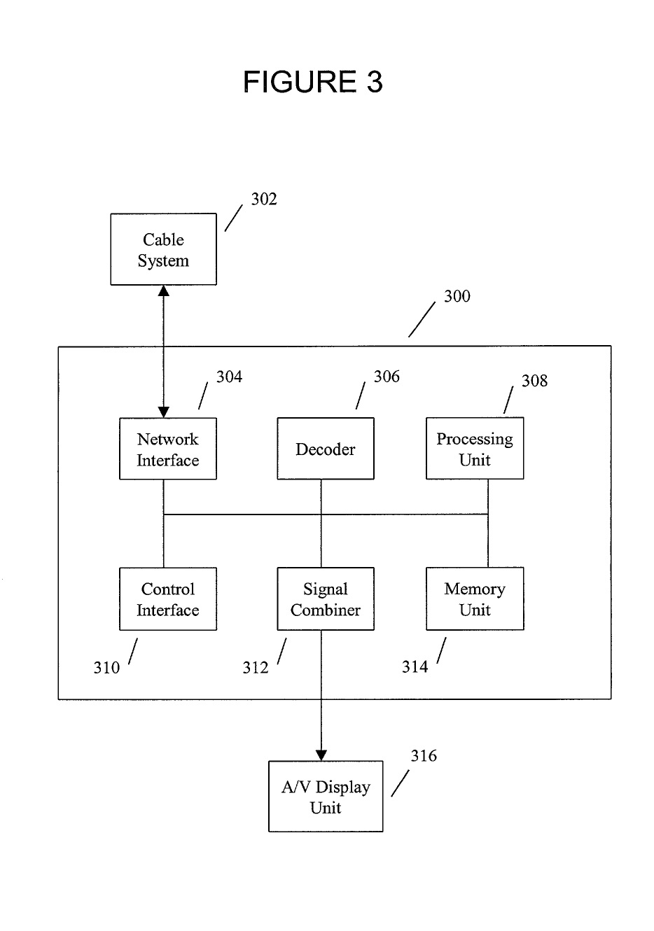

FIG. 3 depicts a set top receiver. Receiver 300 comprises network interface 304, decoder 306, processing unit 308, control interface 310, signal combiner 312, and memory unit 314. Decoder 306 may provide conversion of MPEG data into displayable formats. Control interface 310 may receive signals from a remote control or other input device. Signal combiner 312 is operable to combine video information with other information such as on-screen menus or program guides, for example. Memory unit 314 may contain instructions for processing unit 308 and may contain menu information, channel look-up tables, and other information. Receiver 300 may be updated through downloading of instructions from cable system 302 to memory unit 314. Receiver 300 is connected to cable system 302 via network interface 304. Network interface 304 may comprise analog and digital communications formats and may support upstream communication to cable system 302.

A television channel may be employed to carry one analog television program or may employ digital encoding, such as QAM (Quadrature Amplitude Modulation), or QPSK (Quadrature Frequency Shift Keying) to transmit digital information. Such digital information may comprise signals of a cable modem, or may comprise digital television signals. For cable modems, upstream communications (from the receiver to the head-end or node) typically employ QPSK signaling in frequencies shown at label 202 in FIG. 2. Downstream communication may employ higher frequencies and may employ QAM signaling. Digital television typically employs QAM signaling to transfer MPEG packets for a plurality of television programs within the band used for a single analog channel. For example, digital television may carry 5 or 6 digital programs in the 6 MHz band used for a single analog program broadcast. When a plurality of digital channels are broadcast on a channel, the set top box may, in response to a channel number selected by the viewer, be programmed to tune a specific 6 MHz band (8 MHz for PAL and SECAM) and then present audio and video information from the MPEG stream identified by a set of specific packet IDs (PIDs). A receiver unit such as that depicted in FIG. 3 may employ a lookup table to associate a digital television channel number with a specific analog channel and packet ID.

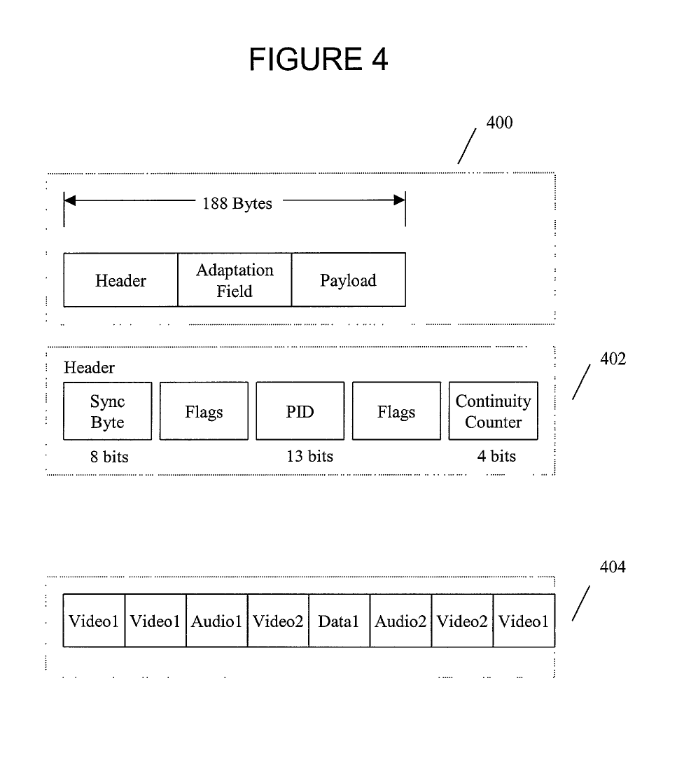

FIG. 4 depicts the format of MPEG packets. Packet 400 comprises header, adaptation field, and payload sections. MPEG-2 employs packets of 188 bytes each. Header information 402 depicts header components, including packet ID (PID). Typically, four types of PIDs are employed. A VPID is the PED for the video stream and an APID is the PID for an audio stream. A PCR PID (program clock reference) may be used to synchronize the video and audio packets. Clock reference data is often embedded into the video stream. A system information PID may be used to indicate data such as a program guide, information about other channels, or may be employed to indicate a data packet not associated with a video or audio program. MPEG stream 404 depicts a stream of packets associated with audio and video for first and second channels, and data for a first data channel. In practice, more audio and video channels, or a greater number of data channels may be present in an MPEG stream.

In an embodiment of the present invention, the receiver of FIG. 3 may be programmed to issue an upstream message to the head-end system when it is first turned on, when it is being turned off, or when it is determined that the viewer has selected a new channel to be viewed. Such determination may comprise a minimum time period for a channel to be selected before it is reported that a new channel has been tuned, thereby accommodating users that flip through a range of channels (i.e. channel surfing), before selecting a channel to view for a more extended duration. Each receiver in the cable as system network communicates the channel tuned when the receiver is turned on (CHON), or the previous channel viewed (CH-OLD) and the new channel (CH-NEW) selected when channels are changed, and the channel tuned when a user selects the ‘off’ button on a remote (CH-OFF), to the head-end system.

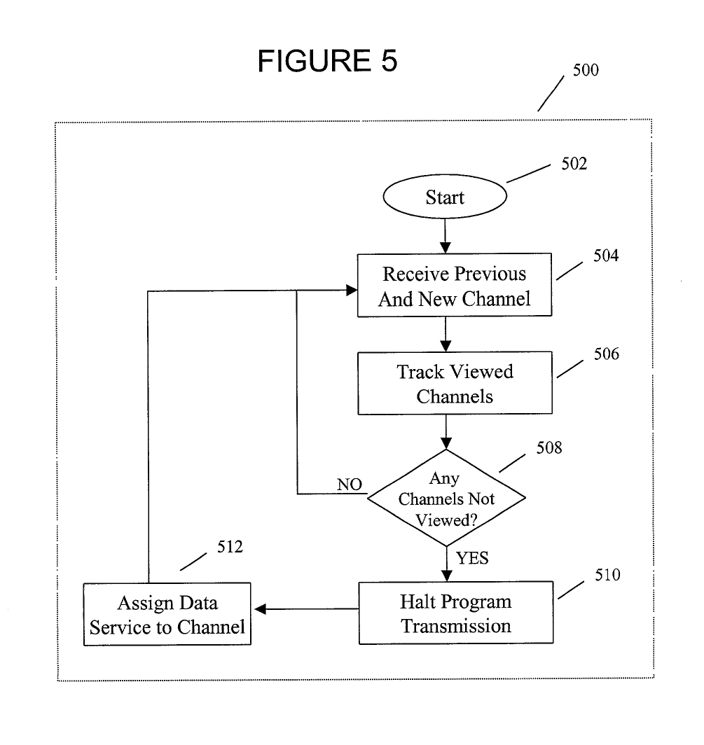

FIG. 5 depicts an algorithm for reassigning channels. Reassignment process 500 starts at step 502. At step 504, information from a receiver indicating CH-ON, CH-OLD and CH-NEW, or CH-OFF, is received. At step 506, a list of viewed channels is produced. Production of the list may comprise establishing a count of viewers for each channel and decrementing the count for each indication CH-OLD or CH-OFF and incrementing the count for each indication of CH-ON or CH-NEW. Receivers may be polled at some time to determine an initial count of channels viewed. At step 508, the list of viewed channels is checked to determine if any channels are not viewed. If all channels are being viewed, processing continues at step 504. If a channel is found that is not being viewed, transmission of the television program on that channel is halted at step 510. At step 512, a data service is assigned to the non-viewed channel. Assignment of the data service may comprise allocating packets in an MPEG stream to data services, or may comprise assigning an entire analog channel for data service communication. An entire analog channel may be assigned to data services if a program broadcast in analog format in the channel is not being viewed, or if all of the programs that may be digitally encoded and broadcast in the analog channel are not being viewed.

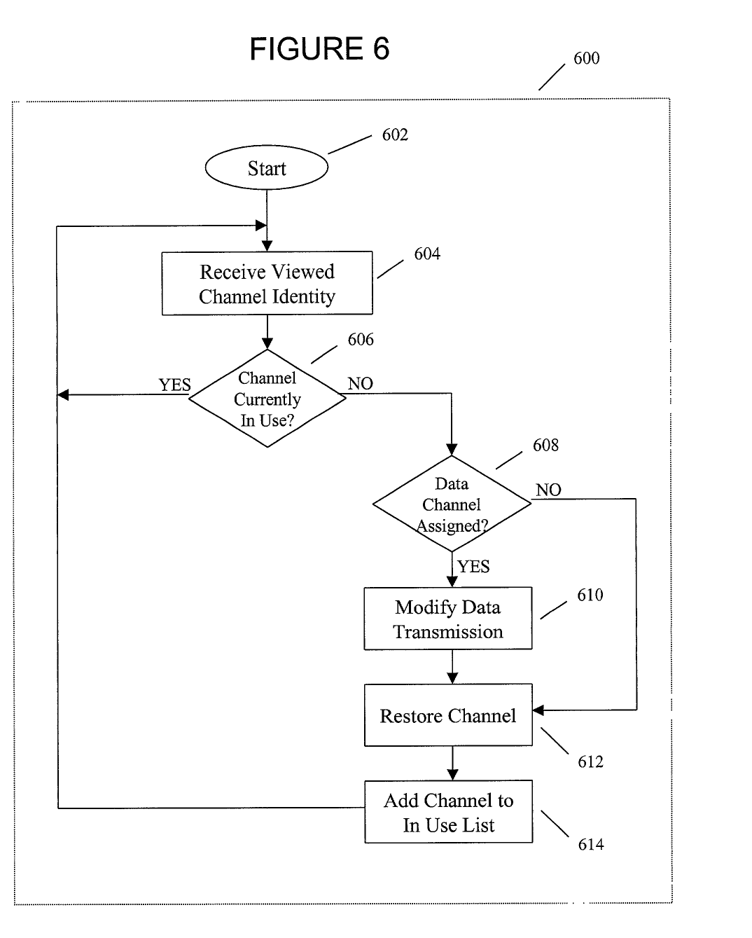

Operating in conjunction with reassignment process 500 is restoration process 600. FIG. 6 depicts an algorithm for restoring service. Restoration process 600 starts at step 602. At step 604, information from a receiver indicating CH-ON or CH-NEW is received. At step 606, the information received in step 604 is compared with a list of channels in use. If the channel is presently being viewed, processing continues at step 604. If the comparison at step 606 finds that the channel tuned is not currently broadcast, step 608 checks if the channel is being used for data services. If step 608 determines that the channel is not being used for data services, program transmission is restored at step 612 and at step 614 the channel is added to the currently viewed list. If step 608 determines that the channel is being used for data services, at step 610 data transmission is modified, then program transmission is restored at step 612 and at step 614 the channel is added to the currently viewed list. Processing then continues at step 604. The modification of data transmission of step 610 may comprise reducing the number of data packets assigned to data services in an MPEG stream, or may comprise assigning data services to a different channel.

In another embodiment of the present invention, the data rate for a non-viewed channel may be reduced such that the displayed image may provide a slower frame rate than full data rate presentations. For example, in MPEG formats, the rate at which new frame information is supplied may be reduced, allowing data services to employ packets not used for the video program. The method of reduced data rate MPEG has the advantage of providing an indication of program content for viewers that may switch (i.e. surf) through channels quickly. If a viewer tunes to a reduced data rate channel for a period beyond a predetermined duration, the data rate may be restored to full data rate. In another embodiment, the data rate of an MPEG stream may be restored to full data rate if paid advertising is being shown.

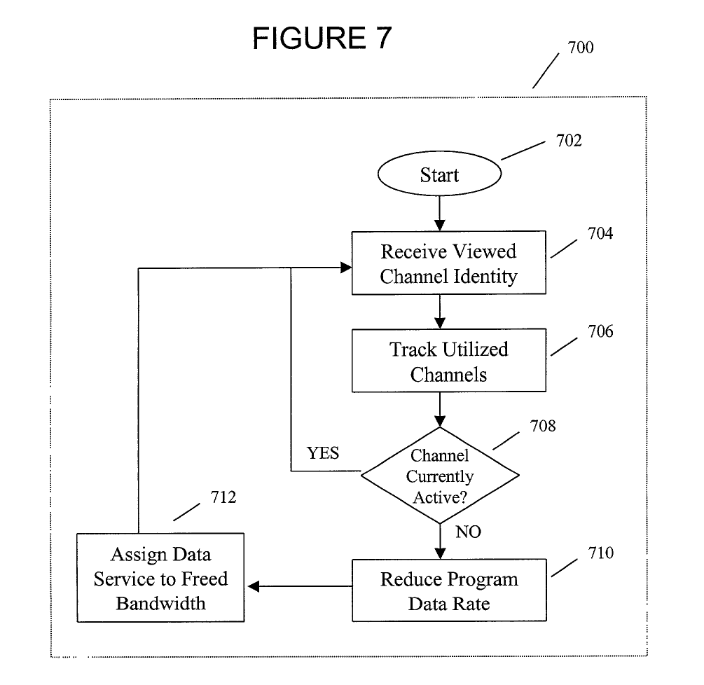

FIG. 7 depicts a second algorithm for reassigning channels. Reassignment process 700 begins at step 702. At step 704, information from a receiver indicating CHON, CH-OLD and CH-NEW, or CH-OFF, is received. At step 706, a list of viewed channels is produced. At step 708, the list of viewed channels is checked to determine if any channels are not viewed. If all channels are being viewed, processing continues at step 704. If a channel is found that is not being viewed, reduced data rate transmission of the program is implemented at step 710. At step 712, a data service is assigned to the bandwidth freed through reduced data rate transmission. Assignment of the data service may comprise allocating packets in an MPEG stream to data services.

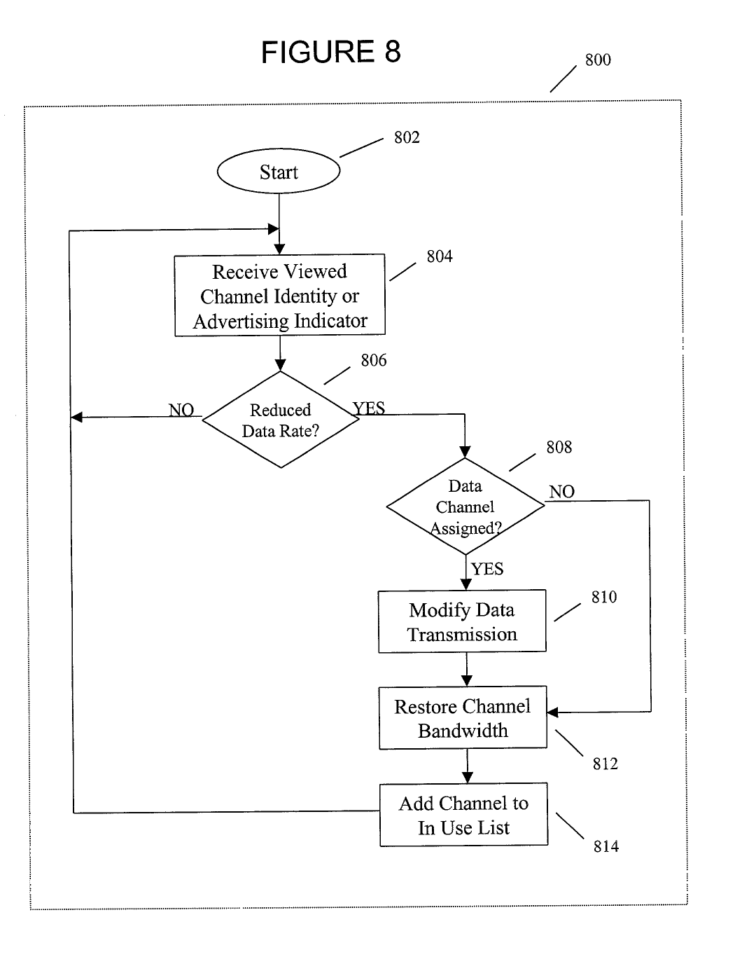

FIG. 8 depicts a second algorithm for restoring service. Restoration process 800 starts at step 802. At step 804, information from a receiver indicating CH-ON, CH-NEW, or, optionally, an indictor of an advertising message is received. At step 806, the information received in step 804 is compared with a list of channels operating at reduced data rates. If the channel is presently presented at full bandwidth, processing continues at step 804. If the comparison at step 806 finds that the channel tuned is broadcast at a reduced data rate, step 808 checks if the channel is being used for data services. If the channel is not being used for data services, full data rate program transmission is restored at step 812 and at step 814 the channel is added to the list of channels presented at full data rate. If step 808 determines that the channel is being used for data services, at step 810 data transmission is modified, then program transmission is restored to full data rate at step 812 and at step 814 the channel is added to the list of channels operating at full data rate. Processing then continues at step 804. The modification of data transmission of step 810 may comprise reducing the number of data packets assigned to data services in an MPEG stream, or may comprise assigning data services to a different channel.

Alternate methods may be employed to determine the channels that are tuned by receivers of the network. For example, receivers may transmit information identifying both the receiver and the channel tuned when turned on or off, or when a new channel is selected, allowing a list of receivers and channels to be formulated and non-tuned channels to be identified. Polling methods may also be employed. For example, if it is determined that the number of viewers for a specific channel is less than a predetermined value, receivers may be polled to confirm the determined value. Further, trend information may be employed to determine channels that exhibit periods when no receivers are tuned, such that only those channels are tracked, reducing the amount of information processed. Restoration of broadcast of a program during advertising has been disclosed. Restoration may also be performed as a result of public service messages such as weather warnings or other information. The foregoing description has employed examples related to cable television systems, however the method and system of the invention may be employed in satellite or other systems where upstream communication is supported.

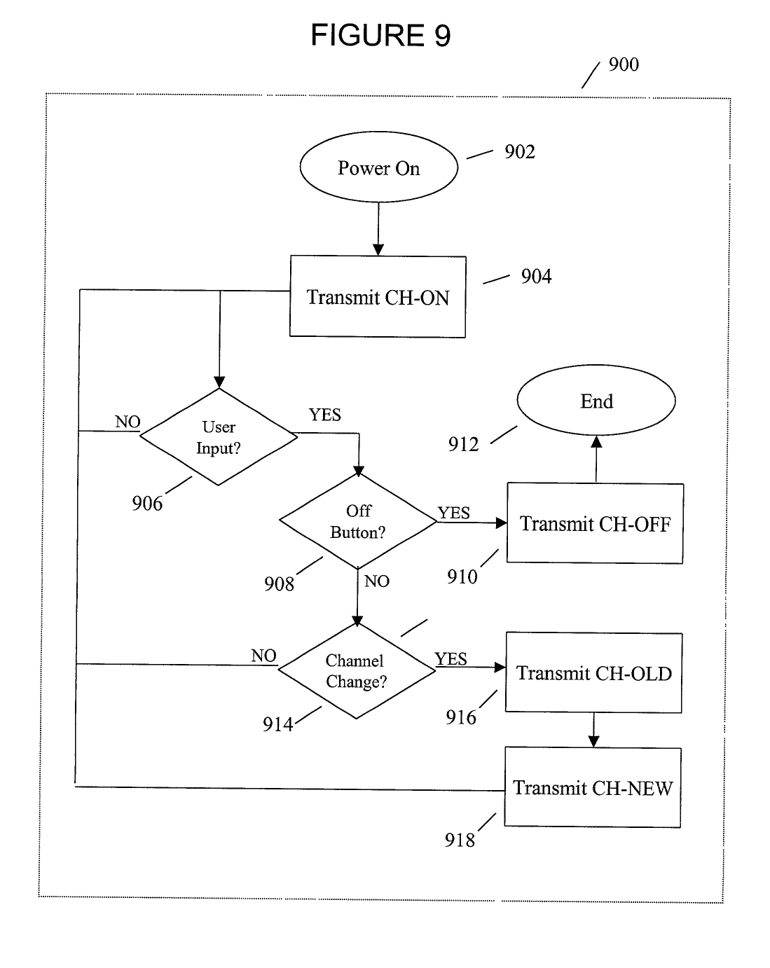

As noted previously, set top boxes, satellite receivers, or other receiving equipment allow downloading of software across a network. FIG. 9 depicts operation of a software program that may be employed by a receiver to transmit channel information to a head-end system or node of a network. Receiver program 900 starts at step 902 where the unit is enabled or powered on. After the receiver is powered on or enabled, step 904 transmits CH-ON. As with most televisions, CH-ON is the channel tuned when the receiver was powered down or disabled and is the channel displayed when the unit is powered on or enabled. After step 904, step 906 determines if user input has been received, such as from a remote control or other input. If no user input has been received, processing continues with step 906. When a user input is received, step 908 checks if the user input is equivalent to an off button selection. If the result of the check performed by step 908 is that an off button has been selected, step 910 transmits a CH-OFF message and processing ends at step 912. If the result of the check performed by step 908 is that an off button was not selected, step 914 checks if the user input was a channel change. If the result of the check or step 914 is that the user input was not a channel change, processing continues at step 906. If the result of the check performed by step 9l4 is that the user input was a channel change, step 916 transmits CH-OLD to indicate the previous channel, and step 918 transmits CH-NEW, indicating the new channel tuned. Processing then continues at step 906. FIG. 9 is illustrative of software that may be employed with one embodiment of the invention. If, as previously mentioned, the receiver is configured to transmit information identifying both the receiver and the channel selected, the method of FIG. 9 may be modified such that steps 910 and 916 are removed, and processing would continue on the path shown following these steps.

The present invention therefore provides a system and method for reallocating bandwidth normally expended transmitting content not viewed, to services that may provide additional user satisfaction and may provide additional revenue. Advantageously the present invention provides a method for timely reestablishment of a broadcast program should a user tune to a previously non-viewed channel. The present invention also provides a method for broadcasting non-viewed programs at reduced bandwidth, providing a representation of channel content for viewers that switch through channels. Further, the present invention provides a method for restoring bandwidth during commercial or public service messages, allowing fulfillment of advertising and community service goals.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of managing television network bandwidth comprising:
broadcasting a plurality of programs on a plurality of channels to a plurality of receivers across said network;
identifying each channel of said plurality of channels that is tuned by at least one receiver of said plurality of receivers connected to said network;
determining if one channel of said plurality of channels is not tuned by any one of said plurality of receivers; and
if one channel of said plurality of channels is not tuned by any one of said plurality of receivers, broadcasting information other than a program on said one channel.

2. The method of claim 1 wherein said step of identifying further comprises:
receiving a signal from each receiver of said plurality of receivers, said signal indicating the channel tuned.

3. The method of claim 1 wherein said step of identifying further comprises:
receiving a signal from each receiver of said plurality of receivers, said signal indicating the channel tuned and the previous channel tuned.

4. The method of claim 1 wherein said step of identifying further comprises:
receiving a signal from each receiver of said plurality of receivers, said signal indicating the channel tuned if a user has selected a receiver function discontinuing reception of any channel.

5. A method for managing network bandwidth comprising:
broadcasting a plurality of programs on a plurality of channels to a plurality of receivers across said network;
defining a group of channels comprising a subset of said plurality of channels;
identifying each channel of said group of channels that is tuned by at least one receiver of said plurality of receivers connected to said network;
determining if one channel of said group of channels is not tuned by any one of said plurality of receivers; and
if one channel of said group of channels is not tuned by any one of said plurality of receivers, broadcasting information other than a program on said one channel.

6. The method of claim 5 wherein said step of identifying further comprises:
receiving a signal from each receiver of said plurality of receivers, said signal indicating the channel tuned.

7. The method of claim 5 wherein said step of identifying further comprises:
receiving a signal from each receiver of said plurality of receivers, said signal indicating the channel tuned and the previous channel tuned.

8. The method of claim 5 wherein said step of identifying further comprises:
receiving a signal from each receiver of said plurality of receivers, said signal indicating the channel tuned if a user has selected a receiver function discontinuing reception of any channel.

9. A method for managing network bandwidth comprising:
broadcasting a plurality of programs on a plurality of channels to a plurality of receivers across said network;
identifying each channel of said plurality of channels that is tuned by at least one receiver of said plurality of receivers connected to said network;
determining if one channel of said plurality of channels tuned is a channel that has been reallocated as a data service channel; and
if one channel of said plurality of channels tuned by any one of said plurality of receivers is a channel that has been reallocated as a data service channel, reestablishing broadcast of a program on said one channel.

10. The method of claim 9 wherein said step of identifying further comprises:
receiving a signal from each receiver of said plurality of receivers, said signal indicating the channel tuned.

11. The method of claim 9 wherein said step of identifying further comprises:
receiving a signal from each receiver of said plurality of receivers, said signal indicating the channel tuned and the previous channel tuned.

12. The method of claim 9 wherein said step of identifying further comprises:
receiving a signal from each receiver of said plurality of receivers, said signal indicating the channel tuned if a user has selected a receiver function discontinuing reception of any channel.

13. A method for managing network bandwidth comprising:
broadcasting a plurality of programs on a plurality of channels to a plurality of receivers across said network;
defining a group of channels comprising a subset of said plurality of channels;
identifying each channel of said group of channels that is tuned by at least one receiver of said plurality of receivers connected to said network;
determining if one channel of said group of channels tuned by any one of said plurality of receivers is a channel that has been reallocated as a data service channel; and
if one channel of said group of channels tuned by any one of said plurality of receivers is a channel that has been reallocated as a data service channel, reestablishing broadcast of a program on said one channel.

14. The method of claim 13 wherein said step of identifying further comprises:
receiving a signal from each receiver of said plurality of receivers, said signal indicating the channel tuned.

15. The method of claim 13 wherein said step of identifying further comprises:
receiving a signal from each receiver of said plurality of receivers, said signal indicating the channel tuned and the previous channel tuned.

16. The method of claim 13 wherein said step of identifying further comprises:
receiving a signal from each receiver of said plurality of receivers, said signal indicating the channel tuned if a user has selected a receiver function discontinuing reception of any channel.

17. A method for managing network bandwidth comprising:
broadcasting a plurality of programs on a plurality of channels to a plurality of receivers across said network;
identifying each channel of said plurality of channels that is tuned by at least one receiver of said plurality of receivers connected to said network;
determining if one channel of said plurality of channels is not tuned by any one of said plurality of receivers; and
if one channel of said plurality of channels is not tuned by any one of said plurality of receivers, broadcasting a program on said one channel at a reduced data rate.

18. The method of claim 17 wherein said step of identifying further comprises:
receiving a signal from each receiver of said plurality of receivers, said signal indicating the channel tuned.

19. The method of claim 17 wherein said step of identifying further comprises:
receiving a signal from each receiver of said plurality of receivers, said signal indicating the channel tuned and the previous channel tuned.

20. The method of claim 17 wherein said step of identifying further comprises:
receiving a signal from each receiver of said plurality of receivers, said signal indicating the channel tuned if a user has selected a receiver function discontinuing reception of any channel.

21. A method for managing network bandwidth comprising:
broadcasting a plurality of programs on a plurality of channels to a plurality of receivers across said network;
defining a group of channels comprising a subset of said plurality of channels;
identifying each channel of said group of channels that is tuned by at least one receiver of said plurality of receivers connected to said network;
determining if one channel of said group of channels is not tuned by any one of said plurality of receivers; and
if one channel of said group of channels is not tuned by any one of said plurality of receivers, broadcasting a program on said one channel at a reduced data rate.

22. The method of claim 21 wherein said step of identifying further comprises:
receiving a signal from each receiver of said plurality of receivers, said signal indicating the channel tuned.

23. The method of claim 21 wherein said step of identifying further comprises:
receiving a signal from each receiver of said plurality of receivers, said signal indicating the channel tuned and the previous channel tuned.

24. The method of claim 21 wherein said step of identifying further comprises:
receiving a signal from each receiver of said plurality of receivers, said signal indicating the channel tuned if a user has selected a receiver function discontinuing reception of any channel.

25. A method for managing network bandwidth comprising:
broadcasting a plurality of programs on a plurality of channels to a plurality of receivers across said network;
identifying each channel of said plurality of channels that is tuned by at least one receiver of said plurality of receivers connected to said network;
determining if one channel of said plurality of channels tuned is a channel that has been configured to operate at a reduced data rate; and
if one channel of said plurality of channels tuned by any one of said plurality of receivers is a channel that has been configured to operate at a reduced data rate, configuring said one channel to operate at a higher data rate.

26. The method of claim 25 wherein said step of identifying further comprises:
receiving a signal from each receiver of said plurality of receivers, said signal indicating the channel tuned.

27. The method of claim 25 wherein said step of identifying further comprises:
receiving a signal from each receiver of said plurality of receivers, said signal indicating the channel tuned and the previous channel tuned.

28. The method of claim 25 wherein said step of identifying further comprises:
receiving a signal from each receiver of said plurality of receivers, said signal indicating the channel tuned if a user has selected a receiver function discontinuing reception of any channel.

29. A method for managing network bandwidth comprising:
broadcasting a plurality of programs on a plurality of channels to a plurality of receivers across said network;
defining a group of channels comprising a subset of said plurality of channels;
identifying each channel of said group of channels that is tuned by at least one receiver of said plurality of receivers connected to said network;
determining if one channel of said group of channels tuned by any one of said plurality of receivers is a channel that has been configured to operate at a reduced data rate; and
if one channel of said group of channels tuned by any one of said plurality of receivers is a channel that has been configured to operate at a reduced data rate, configuring said one channel to operate at a higher data rate.

30. The method of claim 29 wherein said step of identifying further comprises:
receiving a signal from each receiver of said plurality of receivers, said signal indicating the channel tuned.

31. The method of claim 29 wherein said step of identifying further comprises:
receiving a signal from each receiver of said plurality of receivers, said signal indicating the channel tuned and the previous channel tuned.

32. The method of claim 29 wherein said step of identifying further comprises:
receiving a signal from each receiver of said plurality of receivers, said signal indicating the channel tuned if a user has selected a receiver function discontinuing reception of any channel.

33. A method for managing network bandwidth comprising:
broadcasting a plurality of programs on a plurality of channels to a plurality of receivers across said network;
configuring at least one channel of said plurality of channels to operate at a reduced data rate;
determining if a message comprising a commercial message or public service announcement is contained in said one channel; and
if said one channel contains said message, configuring said one channel to operate at a higher data rate.

34. A programmable television receiving unit coupled to network comprising:
a remote user input device;
a program operable to receive a signal from said user input device and to transmit an upstream message if said signal enables said receiving unit to transition from a quiescent state to an operational state.

35. The program of claim 34 wherein said message comprises a channel number.

36. The program of claim 35 wherein said message comprises a receiving unit identifier.

37. The program of claim 34 further comprising:
a routine operable to transmit a message if said signal selects a channel.

38. The program of claim 37 wherein said message comprises a receiving unit identifier.

39. The program of claim 37 further comprising
a routine operable to transmit a message indicating a previous channel if said signal selects a new channel.

40. The program of claim 39 further comprising:
a routine operable to transmit a message if said signal enables said receiving unit to transition from an operational state to a quiescent state.
